(19) United States
(12) Patent Application Publication
(10) Pub. No.: US 2011/0250505 A1
(43) Pub. Date: Oct. 13, 2011

(54) NON-AQUEOUS ELECTROLYTE SECONDARY BATTERY

(75) Inventor: Hizuru Koshina, Mountain View, CA (US)

(73) Assignee: Panasonic Corporation, Osaka (JP)

(21) Appl. No.: 12/757,108

(22) Filed: Apr. 9, 2010

(51) Int. Cl. H01M 6/16; H02J 7/00; B05D 5/12; H01M 10/26; H01M 4/525

(52) U.S. Cl. 429/338; 429/207; 429/342; 429/231.95; 427/77; 320/137

(57) ABSTRACT

A lithium secondary battery comprises a negative electrode, a positive electrode comprising a current collector, an active cathode material comprising a lithium transition metal complex oxide coated on the current collector, and Si_{1-X}Ge_{X}O_{Y} (0≦X≦1, 0≦Y<2), and an electrolyte comprising at least one lithium salt and at least one solvent. The positive electrode comprising Si_{1-X}Ge_{X}O_{Y} (0≦X≦1, 0≦Y<2) generates less heat relative to a positive electrode without Si_{1-X}Ge_{X}O_{Y} (0≦X≦1, 0≦Y<2) throughout a state of overcharge. A method of preparing the positive electrode includes coating a current collector with the active cathode material, drying and calendaring the coated current collector to form the positive electrode, and depositing a calcinated mixture comprising Si_{1-X}Ge_{X}O_{Y} (0≦X≦1, 0≦Y<2) on the positive electrode.

### FIELD OF THE INVENTION

The present invention relates to a cathode for improving the overcharge safety of a lithium battery.

### BACKGROUND OF THE INVENTION

In recent years, electronic information devices, such as personal computers, cell phones, and personal digital assistants (PDA), as well as audio-visual electronic devices, such as video camcorders and MP3 players, are rapidly becoming smaller, lighter in weight, and cordless. Secondary batteries having high energy density are increasingly in high demand as power sources for these electronic devices. Thus, non-aqueous electrolyte secondary batteries, having higher energy density than obtainable by conventional lead-acid batteries, nickel-cadmium storage batteries, or nickel-metal hydride storage batteries, have come into general use. Among non-aqueous electrolyte secondary batteries, lithium-ion secondary batteries, and lithium-ion polymer secondary batteries are under advanced development.

A lithium battery comprises a cathode, an anode, an electrolyte, and a separator disposed between the cathode and anode. Lithium batteries produce electrical energy by intercalation/deintercalation of lithium ions during oxidation and reduction occurring at the anode and the cathode, respectively. If a battery is overcharged, excess lithium is removed from the cathode and deposits on the anode. This can cause the cathode and anode to become thermally unstable, the electrolyte can decompose, and rapid heat generation or thermal runaway can occur resulting in an unsafe battery. Thus, thermal stabilizers have been investigated to suppress or prevent heat generation during overcharge of the battery.

ZrO₂, AlPO₄, Al₂O₃, and AlF₃ have been explored as possible coating materials for the cathode of a lithium ion battery. Those materials may have resulted in improvements of a battery's cycle life at a higher charging voltage and thermal stability by protecting the surface of the layered cathode materials. An effective and appropriate thermal stabilizer, however, was further investigated for cathodes at overcharge.

### SUMMARY OF THE INVENTION

According to an embodiment of the present invention, a lithium secondary battery comprises a negative electrode, a positive electrode comprising a current collector, an active cathode material comprising a lithium transition metal complex oxide coated on the current collector, and silicon, silicon oxide (SiOₓ, 0≦x<2) (hereinafter called SiOₓ), germanium, germanium oxide (GeOₓ, 0≦x<2), and/or Si_{1-X}Ge_{X}O_{Y} (0≦X≦1, 0≦Y<2), and an electrolyte comprising at least one lithium salt and at least one solvent. The positive electrode comprising Si_{1-X}Ge_{X}O_{Y} (0≦X≦1, 0≦Y<2) generates less heat relative to a positive electrode without Si_{1-X}Ge_{X}O_{Y} (0≦X≦1, 0≦Y<2) throughout a state of overcharge.

According to another embodiment of the present invention, a positive electrode for a non-aqueous electrolyte secondary battery comprises a current collector, an active cathode material comprising LiCoO₂ coated on the current collector, and Si_{1-X}Ge_{X}O_{Y} (0≦X≦1, 0≦Y<2). The Si_{1-X}Ge_{X}O_{Y} (0≦X≦1, 0≦Y<2) is a coating on one or both of the current collector and the active cathode material. The positive electrode comprising Si_{1-X}Ge_{X}O_{Y} (0≦X≦1, 0≦Y<2) generates less heat relative to a positive electrode without the coating of Si_{1-X}Ge_{X}O_{Y} (0≦X≦1, 0≦Y<2) throughout a state of overcharge.

According to another embodiment of the present invention, a lithium secondary battery comprises a cathode comprising Si_{1-X}Ge_{X}O_{Y} (0≦X≦1, 0≦Y<2) and a cathode active material comprising a lithium transition metal complex oxide selected from the group consisting of LiCoO₂, LiNiO₂, Li(NiₓMn_{y}CO_{z})O₂ (x+y+z=1), Li(NiₓCO_{y}Al_{z})O₂ (x+y+z=1), LiFePO₄ and Li(Mn₂₋ₓAₓ)O₄ (A is a transition metal, 0≦x<2), an anode comprising a graphite and/or lithium alloy comprising a p-element or transition metal selected from the group consisting of Si, Sn, Al, Pb, Bi, In, Ag, Pt, and Ti, and an electrolyte comprising at least one lithium salt selected from the group consisting of LiPF₆, LiAsF₆, LiBF₄, and LiClO₄ and at least one solvent selected from the group consisting of ethylene carbonate, propylene carbonate, butylene carbonate, ethyl methyl carbonate, dimethyl carbonate, diethyl carbonate, and mixtures thereof. The cathode comprising Si_{1-X}Ge_{X}O_{Y} (0≦X≦1, 0≦Y<2) generates less heat relative to a cathode without Si_{1-X}Ge_{X}O_{Y} (0≦X≦1, 0≦Y<2) throughout a state of overcharge.

According to another embodiment of the present invention, a method of preparing a positive electrode for a lithium secondary battery comprises coating a current collector with an active cathode material comprising LiCoO₂. The coated current collector is dried and calendared to form a positive electrode. Then, Si_{1-X}Ge_{X}O_{Y} (0≦X≦1, 0≦Y<2), optionally, mixed with cathode active materials, are deposited onto the positive electrode. This may occur by vapor deposition, such as physical vapor deposition.

According to another embodiment of the present invention, a method of using a lithium secondary battery comprises overcharging a lithium secondary battery comprising a negative electrode, a positive electrode comprising Si_{1-X}Ge_{X}O_{Y} (0≦X≦1, 0≦Y<2) and an active cathode material comprising a lithium transition metal complex oxide, and an electrolyte comprising at least one lithium salt and at least one solvent. The heat generation of the positive electrode comprising Si_{1-X}Ge_{X}O_{Y} (0≦X≦1, 0≦Y<2) is maintained at levels lower relative to a positive electrode without Si_{1-X}Ge_{X}O_{Y} (0≦X≦1, 0≦Y<2) during the overcharge.

### BRIEF DESCRIPTION OF THE DRAWING

The invention may be understood from the following detailed description of the invention when read in connection with the accompanying drawing. Included in the drawing are the following figures:

FIG. 1 is a graph of the charging and discharging curves according to a comparative example and different embodiments of the present invention;

FIG. 2 is a graph of the overcharging curves according to the comparative example and the embodiments of the present invention shown in FIG. 1;

FIG. 3 is a plot of the differential scanning calorimetry curves of a LiCoO₂ electrode and a PVdF film;

FIG. 4 is a graph of the differential scanning calorimetry curves according to the comparative example and the embodiments of the present invention shown in FIG. 1;

FIG. 5 is a graph of the heat generation at 4.25V and 5.0V according to the comparative example and the embodiments of the present invention shown in FIG. 1; and

FIG. 6 is a schematic drawing of an example of a non-aqueous electrolyte secondary battery.

### DETAILED DESCRIPTION OF THE INVENTION

Aspects of the present invention include a lithium secondary battery; a positive electrode for a non-aqueous electrolyte secondary battery; a method of preparing a positive electrode for a lithium secondary battery; and a method of using a lithium secondary battery.

When a lithium ion battery is overcharged, excess lithium ions are released from a cathode and migrate to an anode, which could cause the cathode and the anode to become thermally unstable. When the cathode and the anode are thermally unstable, an organic solvent, particularly a carbonate-based organic solvent in an electrolytic solution, begins to decompose at 5 volts or higher. Decomposition of an electrolytic solution causes heat runaway, so that the battery may combust, swell, or rupture. Furthermore, the loss of oxygen from charged lithium-transition-metal oxide electrodes, such as LiCoO₂ electrodes, can contribute to exothermic reactions with the electrolyte and with the lithiated carbon negative electrode, and subsequently to thermal runaway if the temperature of the cell reaches a critical value.

Silicon, silicon monoxide (SiOₓ, 0≦x<2), germanium, and germanium oxide (GeOₓ, 0≦x<2) (e.g., Si_{1-X}Ge_{X}O_{Y} (0≦X≦1, 0≦Y<2)) were discovered as thermal stabilizers for charged lithium-transition-metal oxide electrodes. According to one embodiment, a lithium secondary battery comprises a negative electrode, a positive electrode comprising a current collector, an active cathode material comprising a lithium transition metal complex oxide coated on the current collector, and Si_{1-X}Ge_{X}O_{Y} (0≦X≦1, 0≦Y<2), and an electrolyte comprising at least one lithium salt and at least one solvent.

As used herein, “a non-aqueous electrolyte secondary battery” is understood to encompass lithium-ion secondary batteries. A lithium-ion secondary battery generally comprises a cathode, an anode, an electrolyte, and a separator disposed between the cathode and anode. Secondary batteries are also known as rechargeable batteries because lithium batteries produce electrical energy by intercalation/deintercalation of lithium ions during oxidation and reduction occurring at the anode and the cathode, respectively.

As used herein, “electrodes” may encompass both negative and positive electrodes. A “negative electrode” is used interchangeably with the term anode, and a “positive electrode” is used interchangeably with the term cathode. Although it would be readily appreciated by one skilled in the art, that anodic and cathodic reactions may take place at both electrodes depending on the flow of electrons.

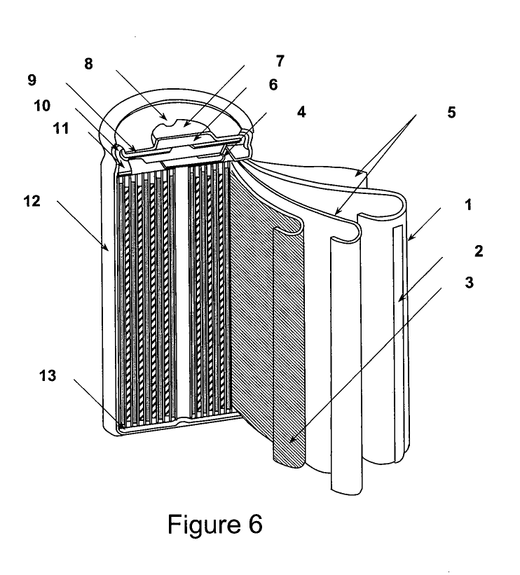

Referring to FIG. 6, the non-aqueous secondary battery may comprise negative electrode 1, negative lead tab 2, positive electrode 3, positive lead tab 4, separator 5, safety vent 6, top 7, exhaust hole 8, PTC (positive temperature coefficient) device 9, gasket 10, insulator 11, battery case or can 12, and insulator 13. Although the non-aqueous secondary battery is illustrated as a cylindrical structure, any other shape, such as prismatic, aluminum pouch, or coin type may be used.

With respect to the positive electrode, it typically comprises a positive electrode current collector and, on the positive electrode current collector, a mixture comprising a positive electrode active material, a conductive material, and a binder.

The positive electrode current collector may be any conductive material that does not chemically or electrochemically change within the range of charge and discharge electric potentials used. The current collector may be a metal, such as aluminum or titanium; an alloy comprising at least one of these metals, such as stainless steel; or stainless steel surface-coated with, e.g., carbon or titanium. The current collector may be, for example, a film, a sheet, a mesh sheet, a punched sheet, a lath form, a porous form, a foamed form, a fibrous form, or, preferably, a foil. In an exemplary embodiment, the current collector is aluminum foil. The current collector may be about 1-500 μm thick.

The positive electrode active material or active cathode material may include any compound containing lithium that is capable of occluding and of releasing lithium ions (Li⁺). A transition metal oxide, with an average discharge potential in the range of 3.0 to 4.0 V with respect to lithium, may be used. A lithium transition metal complex oxide may include lithium cobalt oxide (LiCoO₂), lithium nickel oxide (LiNiO₂), lithium manganese oxide (LiMn₂O₄), lithium iron phosphate (LiFePO₄), lithium nickel manganese cobalt oxide (LiNiₓMn_{y}CO_{z}O₂, x+y+z=1), lithium nickel cobalt aluminum oxide (LiNiₓCO_{y}Al_{z}O₂ x+y+z=1), Li(Mn₂₋ₓAₓ)O₄ (A is a transition metal, 0≦x<2), etc. In an exemplary embodiment, the lithium transition metal complex oxide is LiCoO₂.

At least part of the surface of the positive electrode active material may be covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers, such as carbon fibers and metallic fibers; organic conductive materials, such as polyphenylene derivatives; and mixtures thereof. In an exemplary embodiment, the conductive material is acetylene black.

The binder for the positive electrode may be either a thermoplastic resin or a thermosetting resin. Useful binders include: polyvinyldifluoride also known as polyvinylidene fluoride (PVDF), polyethylene, polypropylene, polytetrafluoroethylene (PTFE), styrene/butadiene rubber, tetrafluoroethylene/hexafluoropropylene copolymers (FEP), tetrafluoroethylene/perfluoro-alkyl-vinyl ether copolymers (PFA), vinylidene fluoride/hexafluoropropylene copolymers, vinylidene fluoride/chlorotrifluoroethylene copolymers, ethylene/tetrafluoroethylene copolymers (ETFE), polychlorotrifluoroethylene (PCTFE), vinylidene fluoride/pentafluoropropylene copolymers, propylene/tetrafluoroethylene copolymers, ethylene/chlorotrifluoroethylene copolymers (ECTFE), vinylidene fluoride/hexafluoropropylene/tetrafluoroethylene copolymers, vinylidene fluoride/perfluoromethyl vinyl ether/tetrafluoroethylene copolymers, and mixtures thereof. In an exemplary embodiment, the binder is polyvinyldifluoride.

The positive electrode for a non-aqueous electrolyte secondary battery comprises silicon or germanium and an active cathode material comprising a lithium transition metal complex oxide. In an exemplary embodiment, the silicon or germanium is in the form of SiOₓ or GeOₓ where x is between about 0 and 2. Also, the silicon and germanium may be used as a mixture of the oxides. Si_{1-X}Ge_{X}O_{Y} (0≦X≦1, 0≦Y<2) may be added to the positive electrode through a number of different techniques. The Si_{1-X}Ge_{X}O_{Y} (0≦X≦1, 0≦Y<2) may be mixed with the active cathode material, e.g., the lithium transition metal complex oxide. This may include mixing the Si_{1-X}Ge_{X}O_{Y} (0≦X≦1, 0≦Y<2) with the active cathode material, the binder, and the conductor. The Si_{1-X}Ge_{X}O_{Y} (0≦X≦1, 0≦Y<2) may be deposited on the surface of the active cathode material, on the surface of the binder, or on the surface of the conductor. The Si_{1-X}Ge_{X}O_{Y} (0≦X≦1, 0≦Y<2) may also be deposited on the surface of the positive electrode by depositing it on the active cathode material and/or on the current collector. In an exemplary embodiment, the Si_{1-X}Ge_{X}O_{Y} (0≦X≦1, 0≦Y<2) is deposited on the surface of the positive electrode as a coating. A “coating” may also include a film coating and may be applied to a certain thickness or a coating weight.

According to an embodiment of the present invention, a positive electrode for a non-aqueous electrolyte secondary battery comprises a current collector, an active cathode material comprising LiCoO₂ coated on the current collector, and Si_{1-X}Ge_{X}O_{Y} (0≦X≦1, 0≦Y<2). The Si_{1-X}Ge_{X}O_{Y} (0≦X≦1, 0≦Y<2) may be a coating on one or both of the current collector and the active cathode material. Thus, the Si_{1-X}Ge_{X}O_{Y} (0≦X≦1, 0≦Y<2) may form a coating on the positive electrode. When the Si_{1-X}Ge_{X}O_{Y} (0≦X≦1, 0≦Y<2) is a film coating on the positive electrode, the coating of Si_{1-X}Ge_{X}O_{Y} (0≦X≦1, 0≦Y<2) may have a thickness of less than about 100 nm. In several exemplary embodiments, the Si_{1-X}Ge_{X}O_{Y} (0≦X≦1, 0≦Y<2) coating may be about 12.2 nm (or 122 Å), about 25 nm (or 250 Å), about 47 nm (or 470 Å), and about 80.7 nm (or 807 Å). More preferably, the thickness of the Si_{1-X}Ge_{X}O_{Y} (0≦X≦1, 0≦Y<2) coating may range from about 10 nm to about 80 nm.

The positive electrode comprising SiOₓ (e.g., silicon monoxide) and/or germanium oxide generates less heat relative to a positive electrode without SiOₓ and/or germanium oxide throughout a state of overcharge. As used herein, “a state of overcharge” is understood to mean when a battery is overcharged or charged above its optimal operating cycle. A charging cycle may be charging at a rate of 0.2 C to 4.25V, and a discharge cycle may be discharging at a rate of 0.2 C to 3.0V. Embodiments of the invention were operated for up to three cycles of charging and discharging before overcharging the battery. Overcharge may be understood to occur at greater than 4.25V, e.g., overcharge may be quantified as charging to 5.0V.

As used herein, “heat generation” is understood to mean the heat produced or generated in the battery, e.g., via the electrode(s) and/or the electrolyte, during operation of the battery. Operation of the battery includes operating the battery by applying voltages, currents, etc. Operation may include operation in excess of the optimal or preferred ranges, e.g., operating the battery at a state of overcharge. Heat generation may be quantified as heat flow in Watts/gram or heat generation in Joules/gram. The heat generation throughout the state of overcharge of the positive electrode with Si_{1-X}Ge_{X}O_{Y} (0≦X≦1, 0≦Y<2) may be up to 50% less relative to a positive electrode without Si_{1-X}Ge_{X}O_{Y} (0≦X≦1, 0≦Y<2). As used herein, “relative to” is understood to mean a comparison of one to another. Thus, the positive electrodes comprising Si_{1-X}Ge_{X}O_{Y} (0≦X≦1, 0≦Y<2) are being compared to a positive electrode without or lacking Si_{1-X}Ge_{X}O_{Y} (0≦X≦1, 0≦Y<2). Heat generation of the electrodes is a valuable metric in determining whether the temperatures of the cell may reach or is likely to reach the critical value leading to thermal runaway. Such a thermal runaway is likely to lead to swelling, rupture, or combustion of the battery.

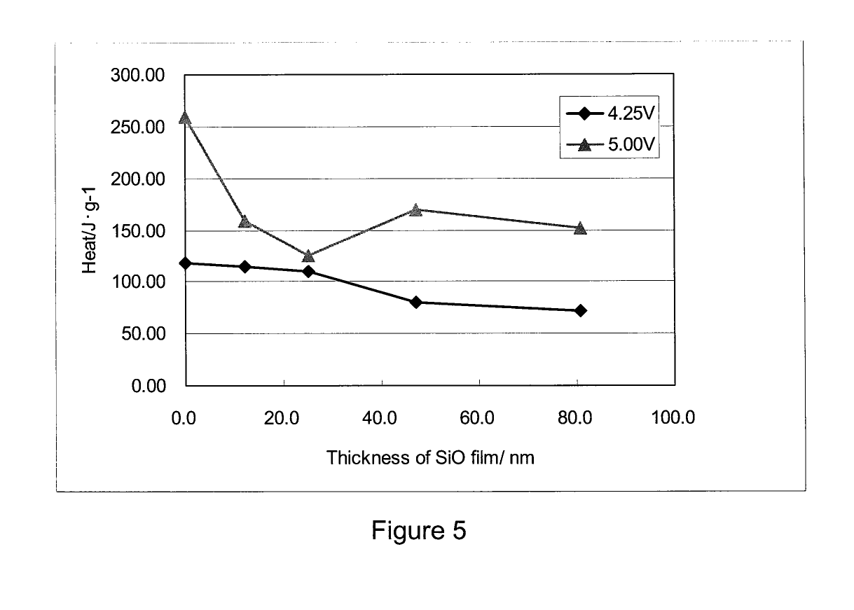

In a particular embodiment, the positive electrode comprising Si_{1-X}Ge_{X}O_{Y} (0≦X≦1, 0≦Y<2) generates less heat relative to a positive electrode without the coating of Si_{1-X}Ge_{X}O_{Y} (0≦X≦1, 0≦Y<2) throughout a state of overcharge. Referring to FIG. 5, the heat generation between 250° C. and 350° C. are summarized. Specifically, FIG. 5 shows the non-SiOₓ coated LiCoO₂ electrode, e.g., 0.0 thickness of SiOₓ film/nm, and the SiOₓ coated LiCoO₂ electrodes at different thicknesses. The heat generation is shown for both a normal charging voltage of 4.25V and overcharging at 5.00V. For example, a non-SiOₓ coated LiCoO₂ electrode generated about 250 Joules/gram of heat, and a 25 nm coating of SiOₓ film generated about 125 Joules/gram of heat. Thus, a 25 nm coating of SiOₓ film evidenced about a 50% reduction in the amount of heat generated for a non-SiOₓ coated LiCoO₂ electrode. In fact, all coatings of SiOₓ showed SiOₓ had the effect of reducing heat generation during over-charging of SiOₓ coated LiCoO₂ electrodes. The SiOₓ also has some effect of reducing heat generation on normal charging of SiOₓ coated LiCoO₂ electrodes at 4.25V. It can also lead to reduced oxygen generation from the cathode, since silicon oxide can absorb oxygen until it becomes SiO₂.

Because the heat generation throughout the state of overcharge of the positive electrode comprising Si_{1-X}Ge_{X}O_{Y} (0≦X≦1, 0≦Y<2) is minimized, it is unlikely the temperatures of the cell would reach the critical value which leads to thermal runaway and ultimately to the consequences of battery swelling, rupture, or combustion. Thus, the safety of the battery is greatly enhanced by adding Si_{1-X}Ge_{X}O_{Y} (0≦X≦1, 0≦Y<2) as a thermal stabilizer.

According to another embodiment of the present invention, a method of preparing a positive electrode for a lithium secondary battery comprises coating a current collector with an active cathode material comprising LiCoO₂. The coated current collector is dried and calendared to form a positive electrode. The Si_{1-X}Ge_{X}O_{Y} (0≦X≦1, 0≦Y<2) is deposited onto the positive electrode by vapor deposition, such as physical vapor deposition, to form a coating of Si_{1-X}Ge_{X}O_{Y} (0≦X≦1, 0≦Y<2).

The positive electrode may be prepared by mixing the positive electrode active material, the binder, and the conductive material with a solvent, such as N-methyl pyrrolidone (NMP). The resulting paste or slurry is coated onto the current collector by any conventional coating method, such bar coating, gravure coating, die coating, roller coating, or doctor knife coating. The current collector may be dried to remove the solvent and then rolled under pressure after coating. The mixture of positive electrode active material, binder, and conductive material may comprise the positive electrode active material, including at least enough conductive material for good conductivity, and at least enough binder to hold the mixture together.

The mixture comprising Si_{1-X}Ge_{X}O_{Y} (0≦X≦1, 0≦Y<2) may include forming a Si_{1-X}Ge_{X}O_{Y} (0≦X≦1, 0≦Y<2) target. The target may be prepared by mixing Si_{1-X}Ge_{X}O_{Y} (0≦X≦1, 0≦Y<2) powder with a binder, such as a polyethylene ionomer or polyvinyl alcohol water base dispersion. The Si_{1-X}Ge_{X}O_{Y} (0≦X≦1, 0≦Y<2) mixture may be formed into a pellet using a die. The die may be, for example, one inch in diameter and the pellet may be formed, for example, under four tons of pressure for one minute. The resulting pellet may be calcinated. Conditions for calcination may include heating to 1050° C. for 10 hours using a tube furnace under argon gas. The calcinated Si_{1-X}Ge_{X}O_{Y} (0≦X≦1, 0≦Y<2) target may then be deposited onto the positive electrode by vapor deposition, e.g., physical or chemical vapor deposition, to form a film of Si_{1-X}Ge_{X}O_{Y} (0≦X≦1, 0≦Y<2). As previously indicated, the film or coating of Si_{1-X}Ge_{X}O_{Y} (0≦X≦1, 0≦Y<2) may be deposited at a thickness of less than about 100 nm.

In an exemplary embodiment, the Si_{1-X}Ge_{X}O_{Y} (0≦X≦1, 0≦Y<2) may be deposited, e.g., by physical vapor deposition, as a mixture with the positive active materials, such as a lithium transition metal complex oxide selected from LiCoO₂, LiNiO₂, Li(NiₓMn_{y}CO_{z})O₂(x+y+z=1), and/or Li(NiₓCO_{y}Al_{z})O₂(x+y+z=1), LiFePO₄, and Li(Mn₂₋ₓAₓ)O₄ (A is a transition metal, 0≦x<2).

With respect to the negative electrode, it also comprises a negative electrode current collector and, on the current collector, a mixture comprising a negative electrode active material, a conductive material, and a binder.

The negative electrode current collector may be any conductive material that does not chemically change within the range of charge and discharge electric potentials used. The current collector may be a metal, such as copper, nickel, iron, titanium, or cobalt; an alloy comprising at least one of these metals such as stainless steel; or copper or stainless steel surface-coated with carbon, nickel or titanium. The current collector may be, for example, a film, a sheet, a mesh sheet, a punched sheet, a lath form, a porous form, a foamed form, a fibrous form, or, preferably, a foil. The current collector may be about 1-500 μm thick.

The negative electrode active material may comprise a graphite and/or lithium alloy. The lithium alloy comprises lithium, and transition metals or p-elements selected from the group consisting of Si, Sn, Al, Pb, Bi, In, Ag, Pt, and Ti. The alloy may take the form of a lithium oxide such as a lithium titanate of Li₄Ti₅O₁₂.

At least part of the surface of the negative electrode active material may be covered with a conductive material. Any conductive material known in the art can be used. Typical conductive materials include carbon, such as graphite, for example, natural graphite (scale-like graphite), synthetic graphite, and expanding graphite; carbon black, such as acetylene black, KETZEN® black (highly structured furnace black), channel black, furnace black, lamp black, and thermal black; conductive fibers such as carbon fibers and metallic fibers; metal powders such as copper and nickel; organic conductive materials such as polyphenylene derivatives; and mixtures thereof.

The binder for the negative electrode may be either a thermoplastic resin or a thermosetting resin. Useful binders include: polyethylene, polypropylene, polyvinylidene fluoride (PVDF), styrene/butadiene rubber, tetrafluoroethylene/hexafluoropropylene copolymers (FEP), tetrafluoroethylene/perfluoro-alkyl-vinyl ether copolymers (PFA), vinylidene fluoride/hexafluoropropylene copolymers, vinylidene fluoride/chlorotrifluoroethylene copolymers, ethylene/tetrafluoroethylene copolymers (ETFE), polychlorotrifluoroethylene (PCTFE), vinylidene fluoride/pentafluoropropylene copolymers, propylene/tetrafluoroethylene copolymers, ethylene/chlorotrifluoroethylene copolymers (ECTFE), vinylidene fluoride/hexafluoropropylene/tetrafluoroethylene copolymers, vinylidene fluoride/perfluoromethyl vinyl ether/tetrafluoroethylene copolymers, and mixtures thereof.

The negative electrode may be prepared by mixing the negative electrode active material, the binder, and the conductive material with a solvent, such as N-methyl pyrrolidone (NMP). The resulting paste or slurry is coated onto the current collector by any conventional coating method, such bar coating, gravure coating, die coating, roller coating, or doctor knife coating. The current collector may be dried to remove the solvent and then rolled under pressure after coating. The mixture of negative electrode active material, binder, and conductive material may comprise the negative electrode active material, including at least enough conductive material for good conductivity, and at least enough binder to hold the mixture together and with current collector. Alternatively, if the active material has good conductivity, conductor materials, e.g., graphite may not be necessary.

With respect to the electrolyte, it comprises a non-aqueous solvent, or mixture of non-aqueous solvents, with a lithium salt or a mixture of lithium salts dissolved therein.

A non-aqueous electrolyte normally selected is one capable of withstanding oxidation at a positive electrode that discharges at a high potential of 3.0 to 4.25V and also is capable of enduring a reduction at a negative electrode that charges and discharges at a potential close to that of lithium. Typically, a non-aqueous electrolyte is obtained by dissolving lithium hexafluorophosphate (LiPF₆) in a mixed solvent of ethylene carbonate (EC), having a high dielectric constant, and a linear carbonate as a low viscosity solvent. Linear carbonates, include, for example, diethyl carbonate (DEC), dimethyl carbonate (DMC), ethyl methyl carbonate (EMC), and similar carbonates.

Thus, non-aqueous solvents may include, for example, cyclic carbonates as ethylene carbonate (EC), propylene carbonate (PC), dipropylene carbonate (DPC), butylene carbonate (BC), vinylene carbonate (VC), phenyl ethylene carbonate (ph-EC), and vinyl ethylene carbonate (VEC); open chain carbonates as dimethyl carbonate (DMC), diethyl carbonate (DEC), ethylmethyl carbonate (EMC); amides, such as formamide, acetamide, and N,N-dimethyl formamide; aliphatic carboxylic acid esters such as methyl formate, ethyl formate, methyl acetate, ethyl acetate, methyl propionate and ethyl propionate; diethers, such as 1,2-dimethoxyethane (DME), 1,2-diethoxyethane (DEE), and ethoxymethoxyethane (EME); cyclic ethers such as tetrahydrofuran, 2-methyl tetrahydrofuran, and dioxane; other aprotic organic solvents, such as acetonitrile, dimethyl sulfoxide, 1,3-propanesulton (PS) and nitromethane; and mixtures thereof.

Lithium salts may include, for example, lithium hexafluorophosphate (LiPF₆), lithium hexafluoroarsenate (LiAsF₆), lithium tetrafluoroborate (LiBF₄), lithium perchlorate (LiClO₄), and mixtures thereof.

The non-aqueous electrolyte may be obtained by dissolving a lithium salt, e.g., lithium hexafluorophosphate (LiPF₆), in a mixed solvent, e.g., of ethylene carbonate (EC), which has a high dielectric constant, and a linear carbonate or a mixture of linear carbonates that are low-viscosity solvents, such as, ethyl methyl carbonate (EMC).

Other compounds may be added to the non-aqueous electrolyte in order to improve discharge and charge/discharge properties. Such compounds include triethyl phosphate, triethanolamine, cyclic ethers, ethylene diamine, pyridine, triamide hexaphosphate, nitrobenzene derivatives, crown ethers, quaternary ammonium salts, and ethylene glycol di-alkyl ethers.

With respect to the separator, it is generally insoluble and stable in the electrolyte solution. The separator's purpose is to prevent short circuits by insulating the positive electrode from the negative electrode. Insulating thin films with fine pores, which have a large ion permeability and a predetermined mechanical strength, may be used. Polyolefins, such as polypropylene and polyethylene, and fluorinated polymers such as polytetrafluoroethylene and polyhexafluoropropylene, may be used individually or in combination. Sheets, non-wovens and wovens made with glass fiber may also be used. The diameter of the fine pores of the separators is typically small enough so that positive electrode materials, negative electrode materials, binders, and conductive materials that separate from the electrodes can not pass through the separator. A desirable diameter may be, for example, 0.01-1 μm. The thickness of the separator may be in the range of 10-300 μm. The porosity is determined by the permeability of electrons and ions, material and membrane pressure and may be in the range of 30-80%.

In one embodiment, a lithium secondary battery comprises a cathode comprising Si_{1-X}Ge_{X}O_{Y} (0≦X≦1, 0≦Y<2) and a cathode active material comprising a lithium transition metal complex oxide selected from the group consisting of LiCoO₂, LiNiO₂, Li(NiₓMn_{y}CO_{z})O₂(x+y+z=1), and Li(NiₓCO_{y}Al_{z})O₂(x+y+z=1), LiFePO₄, and Li(Mn₂₋ₓAₓ)O₄ (A is a transition metal, 0≦x<2); an anode comprising a graphite and/or lithium alloy comprising lithium, and transition metals or p-elements selected from the group consisting of Si, Sn, Al, Pb, Bi, In, Ag, Pt, and Ti; and an electrolyte comprising at least one lithium salt selected from the group consisting of LiPF₆, LiAsF₆, LiBF₄, and LiClO₄ and at least one solvent selected from the group consisting of ethylene carbonate, propylene carbonate, butylene carbonate, ethyl methyl carbonate, dimethyl carbonate, and diethyl carbonate. The cathode comprising Si_{1-X}Ge_{X}O_{Y} (0≦X≦1, 0≦Y<2) generates less heat relative to a cathode without Si_{1-X}Ge_{X}O_{Y} (0≦X≦1, 0≦Y<2) throughout a state of overcharge.

According to one embodiment of the present invention, a method of using a lithium secondary battery comprises overcharging a lithium secondary battery comprising a negative electrode, a positive electrode comprising Si_{1-X}Ge_{X}O_{Y} (0≦X≦1, 0≦Y<2) and an active cathode material comprising a lithium transition metal complex oxide, and an electrolyte comprising at least one lithium salt and at least one solvent. The heat generation of the positive electrode comprising Si_{1-X}Ge_{X}O_{Y} (0≦X≦1, 0≦Y<2) is maintained at levels lower relative to a positive electrode without Si_{1-X}Ge_{X}O_{Y} (0≦X≦1, 0≦Y<2) during the overcharge.

Overcharging the positive electrode releases oxygen which at a high charging state causes instability of the positive electrode active materials. The active oxygen reacts with the electrolyte and generates gases such as carbon dioxide, carbon monoxide, water, hydrogen, etc. If the total volume of these gases is in excess of the capacity of the battery cell, the battery cell will rupture. Without wishing to be bound by a particular theory, silicon, e.g., in the form of SiOₓ, does not dissolve into electrolyte and is stable in high voltage. The positive electrode including the lithium transition metal complex oxide, e.g., LiCoO₂, generates oxygen and the SiOₓ is oxidized to become silicon dioxide (SiO₂). The oxidized SiOₓ attaches to the surfaces of the positive electrode, e.g., LiCoO₂, and silicon dioxide melts on the surface of the LiCoO₂ at high temperatures. This mechanism reduces the heat generated for a charged and/or overcharged LiCoO₂ electrode, where overcharge is charging to greater than 4.25V. Thus, the SiOₓ works as a thermal stabilizer throughout overcharge.

As evidenced in FIG. 5, the method of using a lithium secondary battery includes heat generation during the overcharge of the positive electrode comprising Si_{1-X}Ge_{X}O_{Y} (0≦X≦1, 0≦Y<2) which is up to 50% less relative to a positive electrode without Si_{1-X}Ge_{X}O_{Y} (0≦X≦1, 0≦Y<2). Thus, since heat generation is minimized during the overcharge, the battery is not prone to rupture. Furthermore, the Si_{1-X}Ge_{X}O_{Y} (0≦X≦1, 0≦Y<2) coating may also control the side reaction with the electrolyte and the cathode to minimize overheating and thermal runaway.

### Examples

The following examples are included to more clearly demonstrate the overall nature of the present invention. In particular, the examples describe exemplary methods for making a coated electrode of the present invention which has a reduced heat generation throughout overcharge.

A LiCoO₂ electrode was fabricated according to the following procedure. 0.8496 g of LiCoO₂ powder (FMC Corporation) and 0.0503 g AB (acetylene black, Denka Kogyo K.K.) were mixed well on mortar with pestle after mixing with a vortex mixer (Labnet International, S0100) for 1 minute. 0.8730 g of NMP (N-Methylpyrrolidone, Sigma-Aldrich anhydrous NMP) was added to the mixture of LiCoO₂ powder and AB and then mixed well using vortex mixer for 1 minute. 12%-PVdF (Polyvinyldifluoride, Solvay)/NMP solution of 0.8301 g was added to the mixture and mixed well using vortex for 1 minute. The paste of LiCoO₂, AB, PVdF and NMP was coated on an aluminum foil with 20 μm thickness using a Doctor Blade with a gap of 200 μm and was then dried at 60° C. for 1 hour. After drying, the LiCoO₂ electrode was calendared using a roll press.

A SiOₓ target was made according to the following procedure using physical vapor deposition (called PVD, Kurt J. Lesker PVD75). 2.0007 g of silicon monoxide powder (Sigma-Aldrich, under 325 mesh) was mixed with 0.348 g of binder of S-650 (Mitsui Chemical, 27% polyethylene ionomer water base dispersion). The silicon monoxide and S-650 mixture was formed into a pellet using a dye of 1 inch diameter with 4 tons of force for 1 minute. The pellet was calcinated at 1050° C. for 10 hours using a tube furnace (silica tube with 38 mm diameter) under Argon gas (100 ml/min). The weight of the silicon monoxide pellet increased slightly from 2.0497 g to 2.1909 g. This pellet was used as the silicon monoxide target of physical vapor deposition.

SiOₓ was deposited on the LiCoO₂ electrode with a condition of Forward Power of 32 W, Reflected Power 1.9-2.0 W, DC Bias 208-230V, 15MT 10% FS for argon gas and sample plate rotating speed 4. Calculated thicknesses of SiOₓ were 12.2 nm, 25.0 nm, 47.0 nm, and 80.7 nm.

The calculation was done by following equation and thickness indicator for Al.

T_{SIO}=K(ΔF)/d_{SIO}=(Nₐₜ×d_{q}/F_{q}²)(ΔF)/d_{SIO}

whereas Nₐₜ is the frequency constant of ΔT cut quartz, d_{q} is the density of quartz, F_{q} is uncoated frequencies, ΔF is the frequency change (−2.27 Hz/Å-Al thickness), d_{SIO} is the density of SiOₓ, and T_{Al} is the thickness of aluminum.

$$\begin{matrix}= ( 166.1 KHz \cdot cm \times 2.649 g \text{/} {cm}^{3} ) \times ( 2.27 Hz \text{/} Å ) \times ( {T}_{Al} Å ) / \\ ( {( 6 MHz )}^{2} \times 2.130 g \text{/} {cm}^{3} ) \\ = 1.303 \times {10}^{- 8} cm \times {T}_{Al} \\ = 13.03 \times {T}_{Al} nm\end{matrix}$$

The electrochemical evaluation was carried out with a Swagelok cell. The lithium electrode of 9.2 mm diameter with 0.140 mm thickness was employed as the negative electrode. A porous polypropylene separator (9.8 mm diameter, Celgard #2400, 2 ply) was used. 1M-LiPF₆ in EC (ethylene carbonate, Ferro) and EMC (ethyl-methyl carbonate, Ferro) with volume ratio EC/EMC=1/3 was used as the electrolyte. The LiCoO₂ electrode (punched 8.6 mm diameter), separators, and negative electrode were sandwiched with aluminum pellet (9.4 mm diameter with 1 mm thickness) as a positive current collector and nickel pellet (9.4 mm diameter with 1 mm thickness) as a negative current collector. A spring was used for pressing both electrodes. The Swagelok cells were charged at 0.2 C rate to 4.25V and discharged at 0.2 C rate to 3.0V at first. The Swagelok cells were then over-charged to 4.25 and 5.0V.

After over-charging, the Swagelok cells were disassembled and the LiCoO₂ electrode was rinsed by anhydrous DMC (dimethyl carbonate, Ferro). A sample was taken to an aluminum pan and sealed with an aluminum lid for DSC (TA Instruments, Differential Scanning calorimeter Q10). Samples of the LiCoO₂ electrodes excluding the aluminum foil were measured for thermal behavior by DSC of 5° C./min to 400-500° C.

SiOₓ deposited LiCoO₂ electrodes varied by color based on the film thickness of SiOₓ. A non-SiOₓ coated LiCoO₂ electrode was grey/silver. The color changed brown at 12.2 nm, blue at 25.0 nm, bright green blue at 47.0 nm and bright green brown at 80.7 nm thickness of SiOₓ. These colors remained after over-charging. The Si/O ratio was 1/1.4 determined by EDX (Oxford Instruments INCA model #7021).

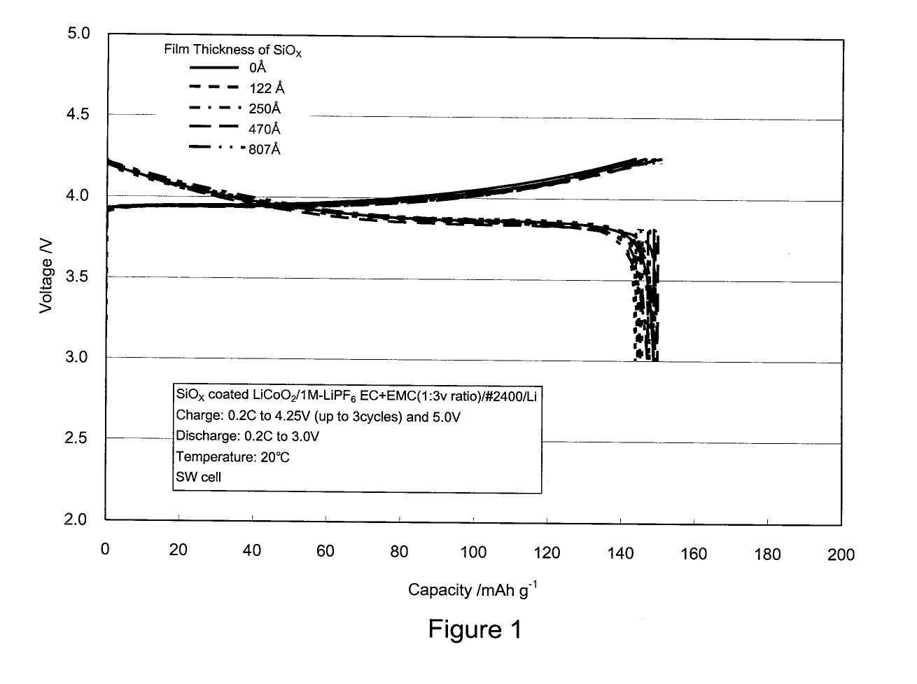

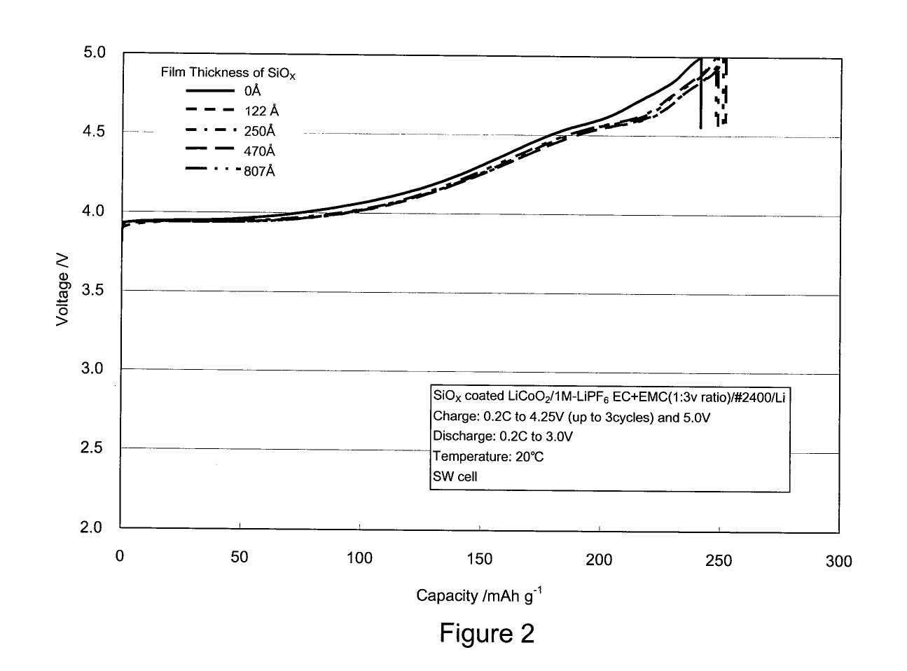

Referring now to FIGS. 1 and 2, charging and discharging curves are shown in FIG. 1 and over-charging curves are shown in FIG. 2. As evident from FIGS. 1 and 2, the SiOₓ coating layer did not influence the electrochemical performance as compared with the non-SiOₓ coated LiCoO₂ electrode.

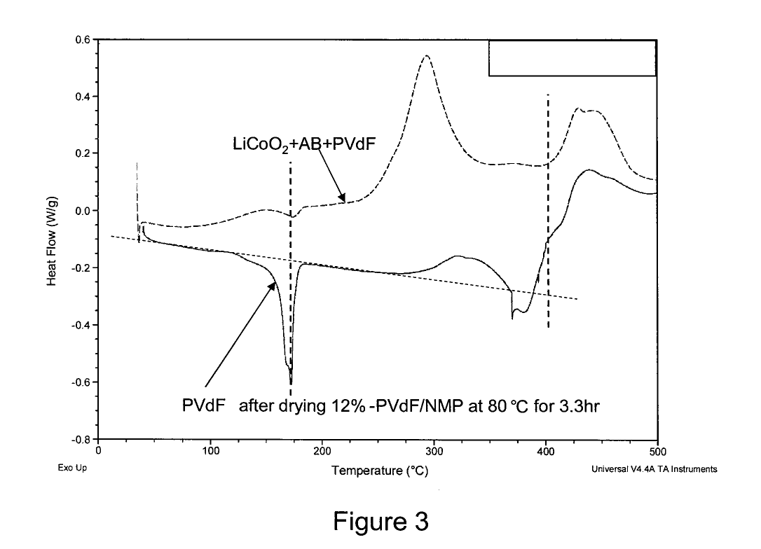

Referring now to FIG. 3, the differential scanning calorimetry (DSC) curves of (a) a non-SiOₓ coated LiCoO₂ electrode and (b) the PVdF film are shown. There is one endothermic peak at 174° C. and four exothermic peaks at 150° C., 294° C., 429° C., 442° C. for the non-SiOₓ coated LiCoO₂. The PVdF film also has one endothermic peak at 175° C. and 370° C., and exothermic peaks at 430° C. and 445° C. The peak at 174° C. may be considered as melting of the PVdF and the peak at 370° C. may be considered fluorine gas released from the aluminum sealed pan after the PVdF has decomposed at about 325° C. When the LiCoO₂ electrode has about 10% of PVdF, the same peaks with PVdF would appear on the LiCoO₂ electrode. These peaks at 429° C. and 442° C. would be considered as a reaction heat with fluorine and the aluminum pan.

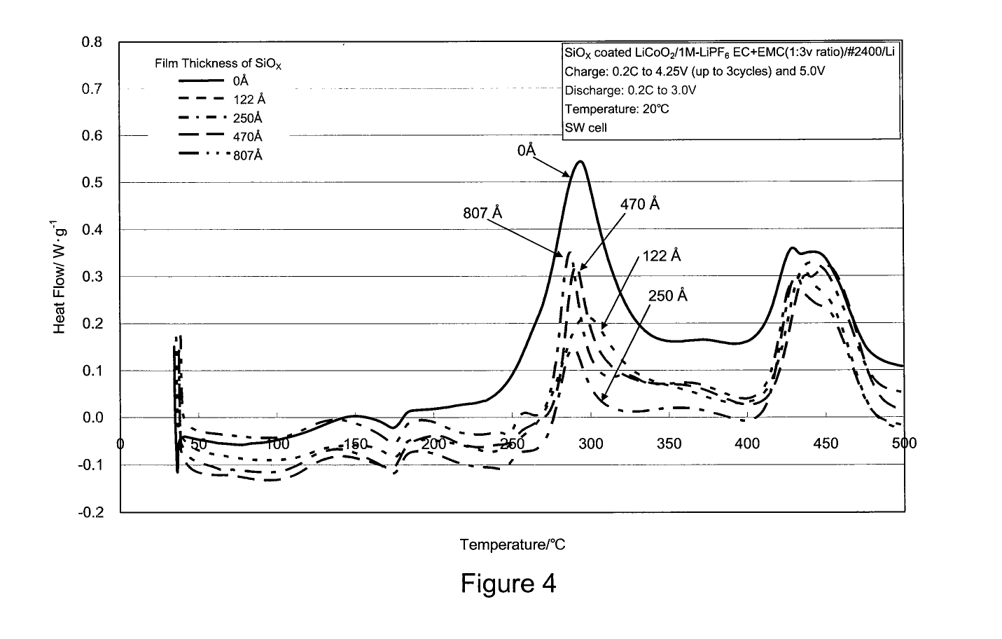

Referring now to FIG. 4, the DSC curves after over-charging to 5V are shown. The DSC curves include (a) a non-SiOₓ coated LiCoO₂ electrode; (b) a 12.2 nm SiOₓ coated LiCoO₂ electrode; (c) a 25.0 nm SiOₓ coated LiCoO₂ electrode; (d) a 47.0 nm SiOₓ coated LiCoO₂ electrode; and (e) a 80.7 nm SiOₓ coated LiCoO₂ electrode. According to the explanation of FIG. 3, the reaction of charged LiCoO₂ would be expected to be limited to between 250° C. and 350° C. During these temperatures, the SiOₓ coated LiCoO₂ electrodes showed smaller heat generation relative to the non-SiOₓ coated LiCoO₂ electrode.

Referring now to FIG. 5, the heat generations between 250° C. and 350° C. are summarized including the non-SiOₓ coated LiCoO₂ electrode and the SiOₓ coated LiCoO₂ electrodes at different thicknesses for both a normal charging voltage of 4.25V and overcharging at 5.00V. As can be seen in FIG. 5, SiOₓ has the effect of reducing heat generation on over-charging SiOₓ coated LiCoO₂ electrodes. The SiOₓ also has some minor effect of reducing heat generation on normal charging of SiOₓ coated LiCoO₂ electrodes.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A lithium secondary battery comprising:
a negative electrode;
a positive electrode comprising a current collector, an active cathode material comprising a lithium transition metal complex oxide coated on the current collector, and Si_{1-X}Ge_{X}O_{Y} (where 0≦X≦1, 0≦Y<2); and
an electrolyte comprising at least one lithium salt and at least one solvent.

2. A lithium secondary battery according to claim 1, wherein the positive electrode comprises SiOₓ which is formed by one of SiOₓ mixed with the lithium transition metal complex oxide to form the active cathode material, a coating of the SiOₓ is deposited on the surface of the active cathode material, and a coating of the SiOₓ is deposited on the surface of the current collector.

3. A lithium secondary battery according to claim 1, wherein the Si_{1-X}Ge_{X}O_{Y} (0≦X≦1, 0≦Y<2) is deposited on the surface of the active cathode material coated on the current collector.

4. A lithium secondary battery according to claim 1, wherein the lithium transition metal complex oxide is selected from the group consisting of lithium cobalt oxide (LiCoO₂), lithium nickel oxide (LiNiO₂), lithium manganese oxide (Li(Mn₂₋ₓAₓ)O₄ where A is a transition metal, 0≦X<2), lithium iron phosphate (LiFePO₄), lithium nickel manganese cobalt oxide (LiNiₓMn_{y}CO_{z}O₂, x+y+z=1), and lithium nickel cobalt aluminum oxide (LiNiₓCO_{y}Al_{z}O₂, x+y+z=1).

5. A lithium secondary battery according to claim 1, wherein the lithium transition metal complex oxide is LiCoO₂.

6. A lithium secondary battery according to claim 1, wherein the negative electrode comprises a graphite and/or lithium alloy comprising a metal selected from the group consisting of Si, Sn, Al, Pb, Bi, In, Ag, Pt, and Ti.

7. A lithium secondary battery according to claim 1, wherein the at least one lithium salt is selected from the group consisting of LiPF₆, LiAsF₆, LiBF₄, and LiClO₄.

8. A lithium secondary battery according to claim 1, wherein the at least one solvent is selected from the group consisting of ethylene carbonate, propylene carbonate, butylene carbonate, ethyl methyl carbonate, dimethyl carbonate, diethyl carbonate, and mixtures thereof.

9. A lithium secondary battery according to claim 1, wherein the at least one solvent comprises a mixture of ethylene carbonate and ethyl methyl carbonate.

10. A lithium secondary battery according to claim 1, wherein the positive electrode comprising Si_{1-X}Ge_{X}O_{Y} (0≦X≦1, 0≦Y<2) generates less heat relative to a positive electrode without Si_{1-X}Ge_{X}O_{Y} (0≦X≦1, 0≦Y<2) throughout a state of overcharge.

11. A positive electrode for a non-aqueous electrolyte secondary battery comprising:
a current collector and an active cathode material comprising LiCoO₂ coated on the current collector, and
a coating of Si_{1-X}Ge_{X}O_{Y} (0≦X≦1, 0≦Y<2) coated on one of the current collector and the active cathode material,
wherein the positive electrode comprising Si_{1-X}Ge_{X}O_{Y} (0≦X≦1, 0≦Y<2) generates less heat relative to a positive electrode without a coating of Si_{1-X}Ge_{X}O_{Y} (0≦X≦1, 0≦Y<2) throughout a state of overcharge.

12. A positive electrode according to claim 11, wherein the coating of Si_{1-X}Ge_{X}O_{Y} (0≦X≦1, 0≦Y<2) has a thickness which is less than about 100 nm.

13. A positive electrode according to claim 11, wherein the heat generation throughout the state of overcharge of the positive electrode comprising Si_{1-X}Ge_{X}O_{Y} (0≦X≦1, 0≦Y<2) is up to 50% less relative to the positive electrode without Si_{1-X}Ge_{X}O_{Y} (0≦X≦1, 0≦Y<2).

14. A lithium secondary battery comprising:
a cathode comprising Si_{1-X}Ge_{X}O_{Y} (where 0≦X≦1, 0≦Y<2) and a cathode active material comprising a lithium transition metal complex oxide selected from the group consisting of lithium cobalt oxide (LiCoO₂), lithium nickel oxide (LiNiO₂), lithium manganese oxide (LiMn₂O₄), lithium iron phosphate (LiFePO₄), lithium nickel manganese cobalt oxide (LiNiₓMn_{y}CO_{z}O₂, x+y+z=1), lithium nickel cobalt aluminum oxide (LiNiₓCO_{y}Al_{z}O₂ x+y+z=1), and Li(Mn₂₋ₓAₓ)O₄ (where A is a transition metal and 0≦x<2);
an anode comprising a graphite and/or lithium alloy comprising a metal selected from the group consisting of Si, Sn, Al, Pb, Bi, In, Ag, Pt, and Ti; and
an electrolyte comprising at least one lithium salt selected from the group consisting of LiPF₆, LiAsF₆, LiBF₄, and LiClO₄ and at least one solvent selected from the group consisting of ethylene carbonate, propylene carbonate, butylene carbonate, ethyl methyl carbonate, dimethyl carbonate, diethyl carbonate, and mixtures thereof;
wherein the cathode comprising Si_{1-X}Ge_{X}O_{Y} (0≦X≦1, 0≦Y<2) generates less heat relative to a cathode without Si_{1-X}Ge_{X}O_{Y} (0≦X≦1, 0≦Y<2) throughout a state of overcharge.

15. A method of preparing a positive electrode for a lithium secondary battery comprising:
coating a current collector with an active cathode material comprising LiCoO₂;
drying and calendaring the coated current collector to form the positive electrode;
preparing and calcinating a mixture comprising Si_{1-X}Ge_{X}O_{Y} (0≦X≦1, 0≦Y<2);
depositing the calcinated mixture comprising Si_{1-X}Ge_{X}O_{Y} (0≦X≦1, 0≦Y<2) onto the positive electrode by vapor deposition to form a coating of Si_{1-X}Ge_{X}O_{Y} (0≦X≦1, 0≦Y<2).

16. A method of preparing a positive electrode according to claim 15, wherein the coating of Si_{1-X}Ge_{X}O_{Y} (0≦X≦1, 0≦Y<2) is about 12 nm to about 80 nm in thickness.

17. A method of using a lithium secondary battery comprising:
overcharging a lithium secondary battery comprising a negative electrode, a positive electrode comprising Si_{1-X}Ge_{X}O_{Y} (0≦X≦1, 0≦Y<2) and an active cathode material comprising a lithium transition metal complex oxide, and an electrolyte comprising at least one lithium salt and at least one solvent,
wherein the heat generation of the positive electrode comprising Si_{1-X}Ge_{X}O_{Y} (0≦X≦1, 0≦Y<2) is maintained at levels lower relative to a positive electrode without Si_{1-X}Ge_{X}O_{Y} (0≦X≦1, 0≦Y<2) during the overcharge.

18. A method of using a lithium secondary battery according to claim 17, wherein during the overcharge the positive electrode comprising Si_{1-X}Ge_{X}O_{Y} (0≦X≦1, 0≦Y<2) generates oxygen and SiOₓ oxidizes to become silicon dioxide.

19. A method of using a lithium secondary battery according to claim 17, wherein the heat generation during the overcharge of the positive electrode comprising Si_{1-X}Ge_{X}O_{Y} (0≦X≦1, 0≦Y<2) is up to 50% less relative to the positive electrode without Si_{1-X}Ge_{X}O_{Y} (0≦X≦1, 0≦Y<2).

20. A method of using a lithium secondary battery according to claim 17, wherein the lithium secondary battery does not rupture during the overcharge.
